(19) United States
(12) Patent Application Publication
(10) Pub. No.: US 2018/0183221 A1
(43) Pub. Date: Jun. 28, 2018

(54) Armored Cable Cutter

(71) Applicant: Wilcox & Son's Electric LLC, Lake Wales, FL (US)

(72) Inventor: Daniel Lyle Wilcox, Lake Wales, FL (US)

(73) Assignee: Wilcox & Son's Electric LLC, Lake Wales, FL (US)

(21) Appl. No.: 15/850,213

(22) Filed: Dec. 21, 2017

Related U.S. Application Data
(60) Provisional application No. 62/439,435, filed on Dec. 27, 2016.

(51) Int. Cl. H02G 1/00; H02K 7/116; H02K 7/14

(52) U.S. Cl. CPC H02G 1/005; H02K 7/145; H02K 7/116

(57) ABSTRACT

A motorized armored cable cutter having a housing containing a motor powered by a power source. The motor is connected to a gearbox. The gearbox transmits rotational force from the motor to an arbor. The arbor rotates a cutting blade. The housing has a guard structure with a cutting blade cover, a primary cable trough, and a lever. The lever has an end configured for a user to depress located opposite another end connected to a secondary cable trough. The housing has a primary cable trough located opposite a secondary cable trough. The primary cable trough and secondary cable trough capture and retain the armored cable. When the lever is depressed by a user, the secondary cable trough is oriented toward the primary cable trough resulting in the armored cable to contact the cutting blade, as the cutting blade protrudes through an opening of the primary cable trough.

### CROSS REFERENCE TO RELATED APPLICATIONS

This application claims priority to U.S. Provisional Patent Application No. 62/439,435, filed Dec. 27, 2016, entitled, “Armored Cable Cutter”.

### BACKGROUND OF THE INVENTION

### 1. Field of the Invention

This invention relates, generally, to a motorized cutting tool. More particularly, it relates to an armored cable cutter having a lever with an end configured for a user to depress and to release located opposite an end configured to capture and retain a portion of an armored cable.

### 2. Background Art

A flexible metal conduit containing insulated electrical service wires is known in the art as an armored cable. The flexible metal conduit of an armored cable is made by a continuously formed spiral of metal. Armored cable needs to be cut to specified lengths. When cutting this armored cable, it is important to cut only the metal portion and not the wires contained within. Commonly, tubing is cut with a tubing cutter that is configured to cut 360 degrees around the tube. This type of cutter cannot be used on armored cable because armored cable has a spiral similar to the threads of a bolt. The use of a tubing cutter on this spiral will not work because the 360 degree spinning of the cutter over the tube will try to traverse up or down the spiral of the flexible metal conduit similar to a nut on a bolt. Additionally, if the current tubing cutters do cut through or even nick the insulation of the wires of the armored cable, the armored cable would become damaged.

Currently, the optimal way of cutting this spiral type of tubing is to cut an incision parallel to the metal conduit so that only one link of the spiral is cut. This allows the metal conduit to be separated. Prior art metal conduit cutters such as those described in U.S. Pat. No. 4,753,007 and U.S. Pat. No. 3,851,387 use a manually rotated cutting blade in which a user is required to crank a mechanical lever to accomplish this cut. The problem with the current design of these cutters is the need for a larger amount of space to fit the cable and winding mechanism of the cutting tool which can be difficult or impossible to operate within the confines of some tightly spaced construction areas. For example, the protruding crank of the blade rotating mechanism of these current cutters can make the cutter rather bulky. Thus, there is a need to eliminate the protruding crank so that the cutter can be more compact.

More particularly, current metal conduit cutters on today's market require the use of two hands to operate. For example, a user's first hand applies pressure to the grip of the cutter and a user's second hand rotates the crank to operate the mechanism which rotates the cutting blade. There is a need for a metal conduit cutter that does not require both of a user's hands to operate. It is more desirable for a metal conduit cutter to have a cutting blade that is powered by a motor rather than powered by a manual crank by a user. This eliminates the need of a user's second hand having to manually crank the lever. Thus, there is a need for a novel armored cable cutter in which a user inserts the metal conduit into a novel clamping mechanism and depresses a button to activate the motor to rotate the cutting blade.

However, in view of the prior art considered as a whole at the time the present invention was made, it was not obvious to those of ordinary skill in the pertinent art how the identified needs could be fulfilled.

### SUMMARY OF THE INVENTION

The long-standing but heretofore unfulfilled need for a motorized armored cable cutter having a housing containing a motor powered by a power source including, but not limited to, a battery, an electrical cord, or by pneumatic air pressure. The motor is connected to a gearbox. The gearbox transmits rotational force from the motor to an arbor. The arbor rotates a cutting blade. The housing has a guard structure with a cutting blade cover, a primary cable trough, and a lever. The lever has an end configured for a user to depress located opposite another end connected to a secondary cable trough. The housing has a primary cable trough located opposite a secondary cable trough. The primary cable trough and the secondary cable trough are configured to capture and retain a portion of an armored cable. When the lever is depressed by a user, the secondary cable trough is oriented toward the primary cable trough resulting in the armored cable to contact the cutting blade, as the cutting blade protrudes through an opening of the primary cable trough, which also includes improvements that overcome the limitations of prior art armored cable cutters is now met by a new, useful, and non-obvious invention.

The novel armored cable cutter has a motor. The motor is coupled to a cutting blade. It is within the scope of this invention for the cutting blade to be rotating or reciprocating. The novel armored cable cutter has a housing having a primary end located opposite a secondary end. A primary cable trough is located opposite a secondary cable trough. The primary cable trough has a mounting side located opposite the primary recess. The primary cable trough is fixedly mounted to the housing, whereby, a portion of the mounting side of the primary cable trough is in communication with the primary and secondary mounting surfaces of the guard structure. The primary cable trough has at least one mounting screw counter bore. A fastener includes, but is not limited to, a screw, can be installed through the mounting screw counter bore of the primary cable trough and through the bore of the mounting surface to mount the primary cable trough to the housing. The tightening and loosening of this fastener can adjust the cutting blade cutting depth. The primary cable trough has a primary recess. The primary cable trough has an opening extending through the primary recess of the primary cable trough and is configured for a portion of the cutting blade to protrude through the opening. This opening allows the cutting blade to pass through the primary cable trough to contact the armored cable. The armored cable is retained in a position that is parallel to both the primary recess of the primary cable trough and the secondary recess of the secondary cable trough.

The armored cable cutter has a lever having a fulcrum point. The secondary cable trough is connected to the lever. The secondary cable trough has a secondary recess configured to retain a portion of an armored cable when the lever is depressed. It is within the scope of the current invention for the lever to be spring loaded. Further, when the handle of lever 9 is depressed, secondary cable trough 8B forces a cable against cutting blade 3 exposed through opening 6 of primary cable trough 8A. It is within the scope of this invention for the opening located between the primary cable trough and the secondary cable trough to be approximately three quarters of an inch in size due to the lever limits. It is also within the scope of this invention for the lever handle portion to be located on the same side as the secondary trough. It is also within the scope of the current invention for the armored cable cutter to simultaneously capture a cable in the primary and secondary troughs and to engage the switch to activate the motor when a lever is depressed by a user. For example, when the lever is depressed by a user, the switched is engaged by the lever, thereby, activating the motor. The depressed lever also retains the cable within the primary and secondary troughs.

In an alternate embodiment, the armored cable cutter housing can have a handle that is hingedly pivotable at fulcrum point 10. The handle has an end having two portions configured for a user to depress to orient secondary cable trough 8B toward primary cable trough 8A, similar to tongs. This allows a greater opening between the primary cable trough and the secondary cable trough than in the aforementioned embodiment.

Switch 11 is in communication with motor 2, whereby, the switch engages the motor causing the cutting blade to rotate or reciprocate to separate a portion of the armored cable. In a preferred embodiment, the switch is an electrical switch. It is within the scope of this invention for the switch to be a pneumatic switch.

It is within the scope of this invention for a pneumatic motor to provide a rotational force using compressed gas to spin the motor. Vessels can contain compressed gas including, but not limited to, carbon dioxide or air. In an alternate embodiment, the motor can be powered from many sources including, but not limited to, a battery, an electrical cord, or an airline going to a compressor or a compressed gas cylinder. It is therefore an important object of the present invention to provide a motor that can be electrically or pneumatically powered.

In another embodiment the recess of the secondary cable trough can have an adjustable protrusion structure protruding from an inner wall surface of the secondary recess. The protrusion structure has an end that can be tightened or loosened to adjust the length the protrusion structure protrudes from the secondary recess. It is within the scope of this invention for the protrusion structure to include, but not be limited to, a fixed protrusion or a spring loaded ball. For example, a spring loaded ball can keep tension on the cable and can position the armored cable close to the cutting blade. The protrusion has a size great enough to fit into the armored cable spiral and position the armored cable below the center of the cutting blade.

In another embodiment, arbor 15 has an end having a bore that receives the gearbox output shaft located opposite and end that is the thread for cutting blade 3 and arbor mounting nut. Arbor 15 has a shoulder to locate arbor ball bearings 16A and 16B. In a preferred embodiment, two arbor ball bearings are used to support the arbor relative to side loading during use. The arbor bearing minimizes the axial space between the gearbox housing face on the output shaft end of the gearbox and the arbor. The arbor holds and drives the cutting blade. This arbor is pressed onto the output shaft of the gearbox. The arbor bearing or thrust bearing is placed over the output shaft and abuts the front face of the gearbox. The opening of the arbor bearing receives a portion of the arbor and rests against the shoulder of the arbor. The arbor press is used to press the arbor over the output shaft of the gearbox. Proper axial spacing is achieved using backup tooling to hold the planetary gearing in the gearbox forward towards the output shaft while the arbor is being pressed on. The arbor bearing provides a low friction spacer between the fixed front face of the gearbox and the rotating arbor.

In yet another embodiment, the housing of the armored cable cutter has a compartment. The compartment of the housing has an inner wall surface. A plurality of protrusions are connected to the inner wall surface of the housing. These ribs or protrusions retain and support including, but not limited to, the battery, the motor, the gearbox, and the arbor assembly in position both radially and axially. It is within the scope of this invention for the ribs to have at least one recess located on a surface thereon.

In a preferred embodiment, a guard structure is connected to the secondary end of the housing assembly. The housing has a guard structure retaining the cutting blade. An inner wall surface of the guard structure has a mounting structure having a primary mounting surface having at least one opening and a secondary mounting surface having at least one opening. The openings of the mounting surface receive a fastener which secures the primary cable trough fixedly onto the guard structure of the housing. It is within the scope of this invention for the primary cable trough to be adjustably mounted to the mounting structure with at least one fastener. It is within the scope of this invention for a barrier element, including but not limited to, spring washers, Bellville washers, or elastomeric spacers to be placed between the fastener and a mounting surface to permit adjusting the cutting blade depth of the cut.

### BRIEF DESCRIPTION OF THE DRAWINGS

For a fuller understanding of the nature and objects of the invention, reference should be made to the following detailed description, taken in connection with the accompanying drawings, in which:

FIG. 1 is a side perspective view of the novel armored cable cutter;

FIG. 2 is a front perspective view of the novel armored cable cutter;

FIG. 3 is a side cut-away view of the guard structure of the novel armored cable cutter;

FIG. 4 is a cut-away view of the novel armored cable cutter;

FIG. 5 is an exploded view of the novel armored cable cutter;

FIG. 6 is a perspective cut-away view of the housing and guard structure of the novel armored cable cutter; and,

FIG. 7 is an exploded partial view of the primary cable trough and the secondary cable trough of the novel armored cable cutter.

### DETAILED DESCRIPTION OF THE PREFERRED EMBODIMENT

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

In a general embodiment the novel armored cable cutter 1 has housing 4 having a plurality of protrusions including, but not limited to, protrusions 19A-19L, located on inner wall surface 31 of housing 4. The plurality of protrusions 19A-19L support and retain including, but not limited to, battery 12, motor assembly 2, gearbox 14, arbor 15, and arbor bearings 16A and 16B. The plurality of protrusions 19A-L secure these components within housing 4 both radially and axially. It is within the scope of this invention for housing 4 of novel armored cable cutter 1 to have at least one protrusion 19 or no protrusions.

In a preferred embodiment, the housing has guard structure 20 forming compartment 32 around at least a portion of cutting blade 3. Guard structure 20 has primary end 33 located opposite secondary end 34. Primary end 33 of guard structure 20 has opening 35 configured to receive a portion of arbor. Secondary end 34 of guard structure 20 is configured to connect with removable blade cover 17. Cutting blade cover 17 mounts to secondary end 34 of guard structure 20 with including, but not limited to, a fastener, adhesive, or a latching mechanism. It is within the scope of this invention for a fastener to include, but not be limited to at least one screw.

Primary cable trough 8A can have mounting screw counter bores 18A and 18B configured to receive a fastener 23. Fastener 23 is capable of mounting primary cable trough 8A to guard structure 20. Fastener 23 is also capable of adjusting the cutting depth of cutting blade 3. It is within the scope of this current invention for the nominal cutting depth to include, but not be limited to, 0.090 inches. Primary cable trough 8A has primary recess 5A that is configured to align a metal conduit cable 21 to pass through while being cut by cutting blade 3. It is within the scope of this current invention for a spacer including, but not limited to, a spring washer, a Belleville spring washer, an elastomeric spacer to be placed around the fasteners in an orientation between the surfaces to permit adjusting the cutting blade 3 depth of cut.

In another embodiment, primary cable trough 8A has primary recess 5A. Secondary cable trough 8B has secondary recess 5B. The primary recess 5A and/or secondary recess 5B can have at least one end that is beveled 38. For example, both ends of secondary cable trough 8B have beveled end portions 38. Beveled end portions 38 are configured to orient the portion of the armored cable 21 that is protruding from the novel armored cable cutter 1 during use in a downward orientation. In another embodiment, primary trough 8A and/or secondary trough 8B can have an arch which conforms to the outer perimeter wall surface of cable 21. It is a preferred embodiment for at least one trough including, but not limited to, troughs 8A and 8B to have an arch 39 to better support cable 21 and to orient the end portions of cable 21 that are protruding from the trough to hang below the trough in a downward orientation.

Although not a preferred embodiment, it is also within the scope of the current invention for troughs 8A and 8B to not have an arch and to not have a beveled end portion.

### Construction of the Novel Armored Cable Cutter

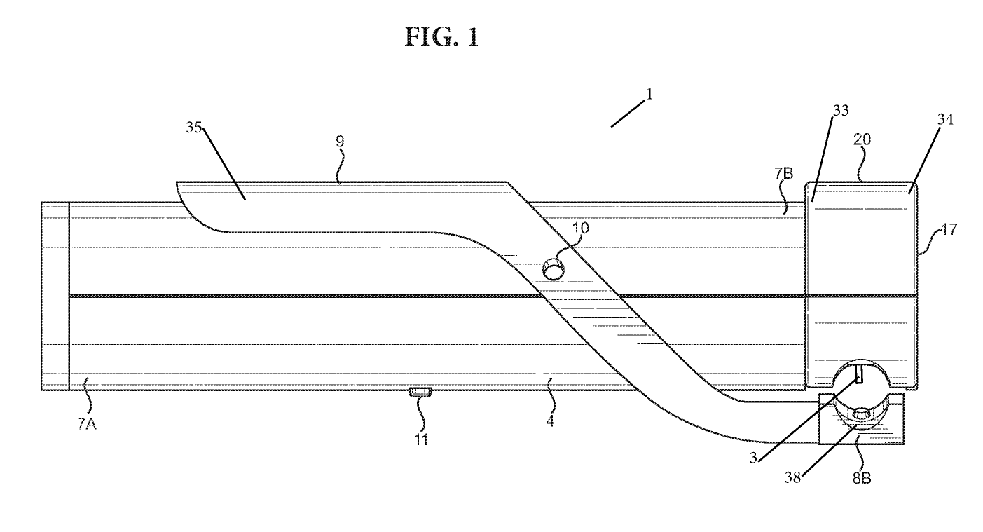

It will now be seen, referring to FIG. 1, armored cable cutter 1 has housing assembly 4 with primary end 7A located opposite secondary end 7B. Primary end 33 of guard structure 20 is connected to secondary end 7B of housing 4. FIGS. 1, 4, and 5 illustrate lever 9 being connected to housing assembly 4 at fulcrum point 10. Lever 9 has a handle portion 35 at one end located opposite secondary cable trough 8B. Housing 4 has switch 11.

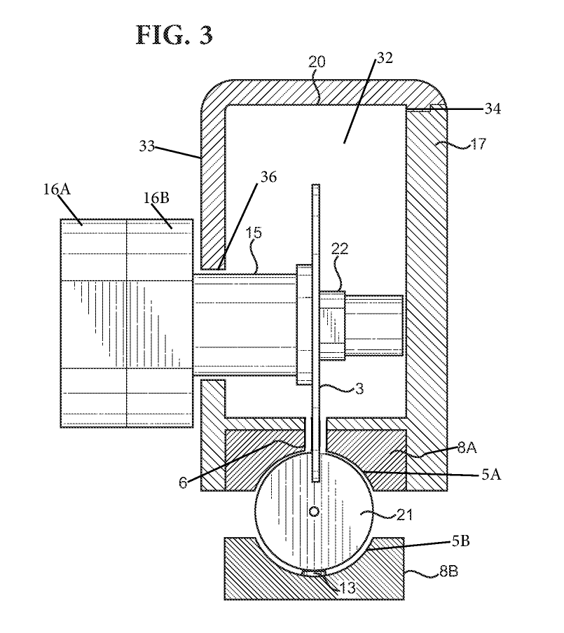

FIGS. 1 and 3 depict guard structure 20 having primary end 33 located opposite secondary end 34. Secondary end 34 (FIGS. 1, 3, and 6) of guard structure 20 is connected to blade cover 17. Guard structure 20 retains cutting blade 3. Guard structure 20 is connected to primary cable trough 8A (FIG. 3).

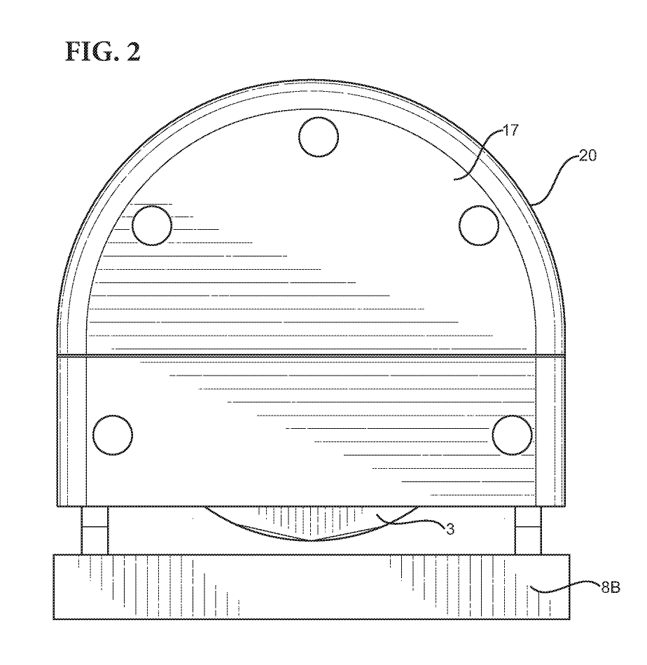

FIGS. 2 and 3 illustrate cutting blade cover 17 connected to guard structure 20. Blade cover 17 is removable for access to compartment 32 (FIG. 3). It is desirable to have access to compartment 32 (FIG. 3) of guard structure 20 to replace cutting blade 3. Cutting blade cover 17 is a barrier to prevent a user's hand (not shown) from contacting cutting blade 3 when in use. Cutting blade 3 is retained in guard structure 20. Primary cable trough 8A (FIG. 3) is located opposite secondary cable trough 8B.

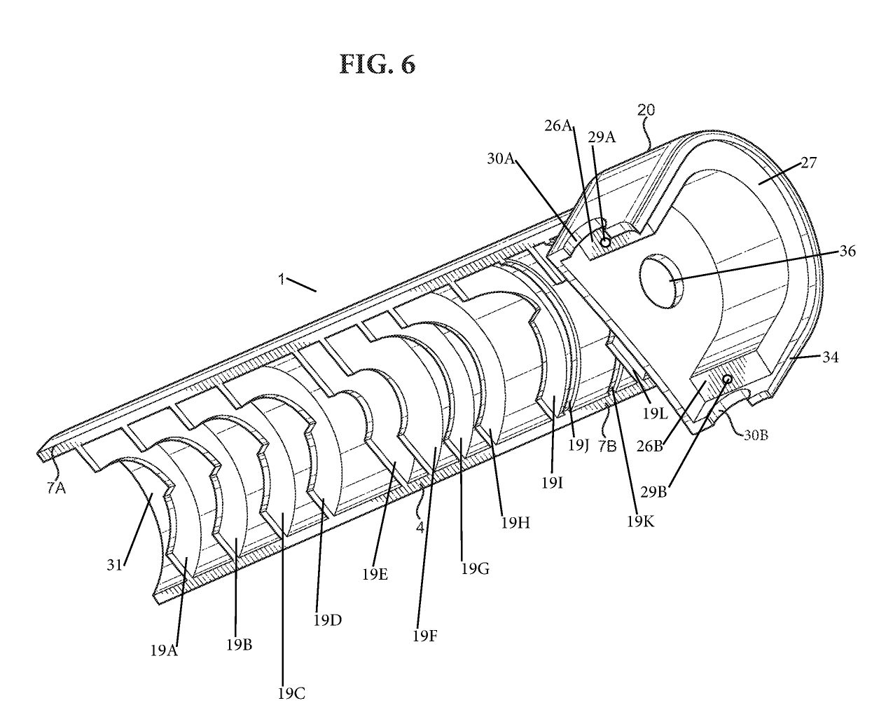

FIG. 3 shows primary end 33 of guard structure 20 having opening 36 (FIGS. 3 and 6). Opening 36 receives arbor 15. Arbor bearings 16A and 16B are connected to arbor 15. Arbor nut 22 is connected to arbor 15. Armored cable 21 is retained by primary cable trough 8A and by secondary cable trough 8B. FIGS. 3-5, and 7 illustrate primary cable trough 8A having recess 5A and opening 6. Secondary cable trough 8B has secondary recess 5B. Protrusion 13 is located on a wall surface of secondary recess 5B. FIGS. 1, 3, 4, and 7 best illustrate secondary cable trough 8B having beveled end portion 38.

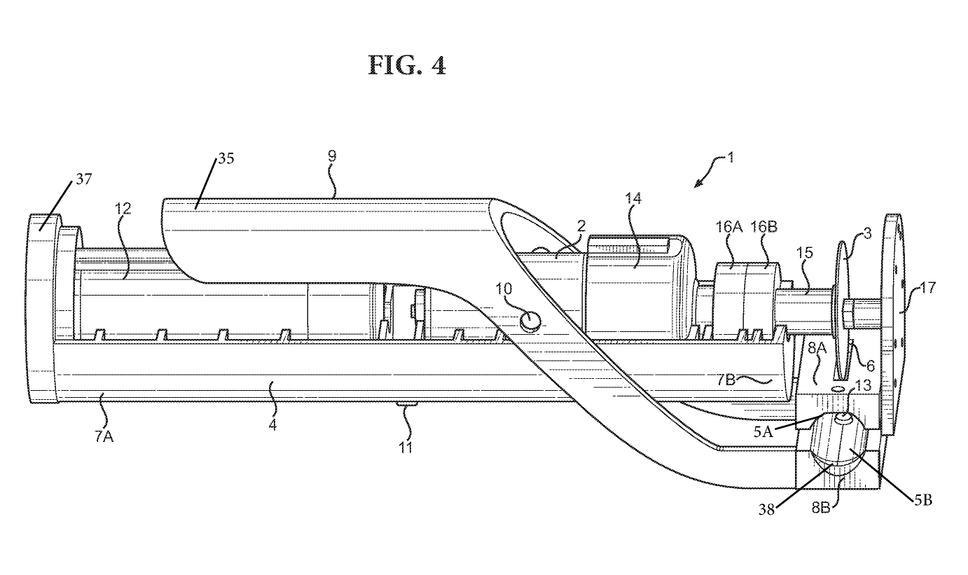

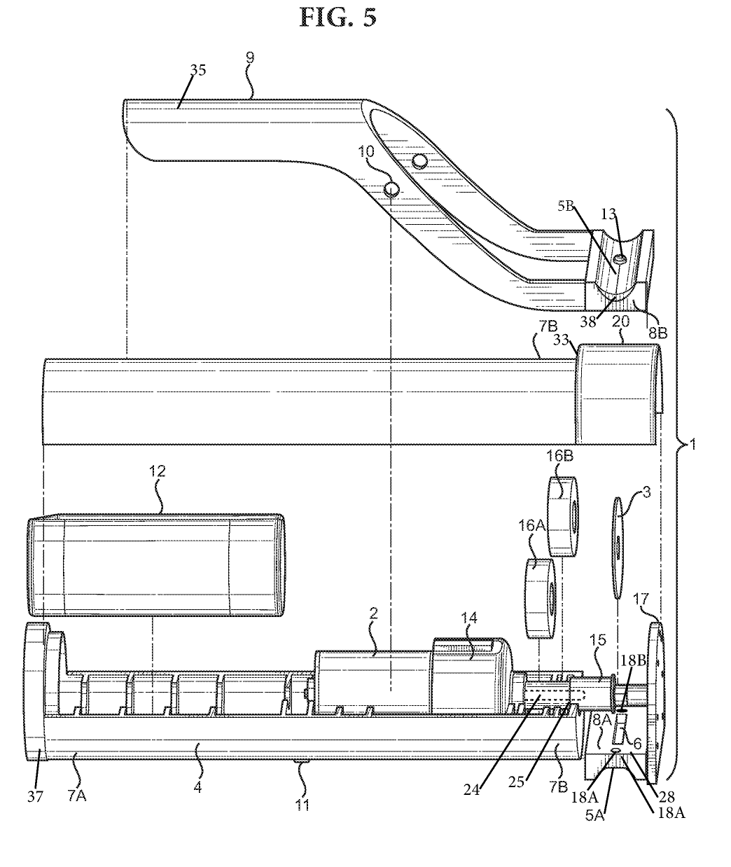

Referring now to FIGS. 4 and 5, housing 4 has primary end 7A located opposite secondary end 7B. Primary end 7A of housing assembly 4 can have removable end cap 37 for access to the battery compartment during installation or removal of battery 12. The end cap also holds the battery in place. Armored cable cutter 1 has battery 12 in communication with motor 2. Motor 2 is connected to gearbox 14. Gearbox 14 transmits rotational force from motor 2 to arbor 15. It is within the scope of this invention for arbor 15 to have arbor bearings 16A and 16B including, but not limited to, a ball bearing, to support arbor 15 relative to side loading while a cable is being cut. Arbor 15 rotates cutting blade 3. Cutting blade cover 17 is located on an end of arbor 15.

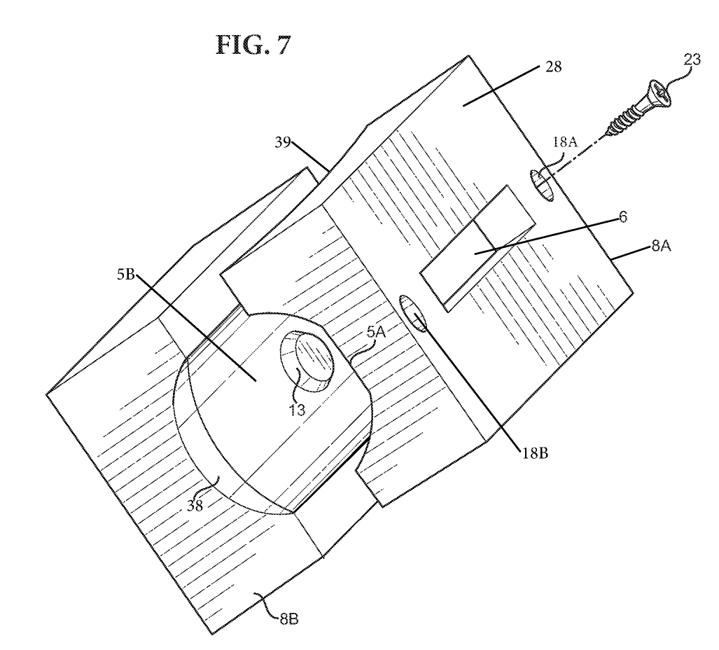

FIG. 5 shows primary end 33 of guard structure 20 is connected to secondary end 7B of housing 4. Gearbox 14 has output shaft 24 that is received by an opening of arbor 15. Arbor 15 has arbor shoulder 25. FIGS. 5 and 7 show primary cable trough 8A having mounting side 28 having mounting screw counter bores 18A and 18B. Fastener 23 (FIG. 7) is received by counter bore 18A. FIG. 7 best illustrates primary trough 8A having primary recess 5A having arch 39 and beveled portion 38 located on an end of secondary trough 8B.

FIG. 6 shows novel armored cable cutter 1 with housing 4 having primary end 7A located opposite secondary end 7B. A plurality of protrusions 19A-19L are connected to inner wall surface 31 of housing 4. Guard structure 20 has recesses 30A and 30B. Mounting structure 27 is connected to an inner wall surface of guard structure 20. Mounting structure 27 has primary mounting surface 26A having primary bore 29A and secondary mounting surface 26B having secondary bore 29B.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now that the invention has been described,

The invention claimed is:

1. A motorized armored cable cutter, comprising:
a housing, said housing having a compartment, said housing having a first end located opposite a second end, said housing comprising:
a power source;
a motor, said motor is connected to said power source, whereby, said motor is powered by said power source;
a gear box, said gear box having a first end located opposite a second end, said first end of said gearbox is connected to said motor, said second end of said gearbox having an output shaft, said gearbox is configured to transmit a rotational force from said motor to an arbor;
an arbor, said arbor having a first end located opposite a second end, said first end of said arbor having a bore, whereby, said bore receives said output shaft of said gearbox, said arbor having a shoulder;
at least one arbor bearing, said at least one arbor bearing is connected to said arbor, whereby, said shoulder of said arbor is configured to locate said at least one arbor bearing;
a cutting blade, said cutting blade is connected to said second end of said arbor;
a guard structure, said guard structure is connected to said second end of said housing, said guard structure is configured to retain said cutting blade;
a first cable trough, said first cable trough having a mounting side located opposite a first recess, said first cable trough having an opening, said mounting side of said first cable trough is connected to said guard structure, thereby, orienting said cutting blade through said opening of said first cable trough;
a second cable trough, said second cable trough having a second recess;
a lever, said lever is connected to said housing, said lever having a handle located opposite said second cable trough; and,
said first cable trough is located opposite said second cable trough, whereby, said said first recess of said first cable trough and said second recess of said second cable trough are configured to capture and retain at least a portion of an armored cable when said lever is depressed.

2. The motorized armored cable cutter of claim 1, further comprising said power source being a battery.

3. The motorized armored cable cutter of claim 1, further comprising said power source being an electrical cord.

4. The motorized armored cable cutter of claim 1, further comprising said power source being pneumatic air pressure.

5. The motorized armored cable cutter of claim 1, further comprising said arbor rotates said cutting blade.

6. The motorized armored cable cutter of claim 1, further comprising said arbor reciprocates said cutting blade.

7. The motorized armored cable cutter of claim 1, further comprising said guard structure having a removable blade cover connected thereto.

8. The motorized armored cable cutter of claim 1, further comprising said first cable trough having at least one bore, said at least one bore receives a fastener, thereby, mounting said first cable trough to said guard structure.

9. The motorized armored cable cutter of claim 1, further comprising said lever being spring loaded.

10. The motorized armored cable cutter of claim 1, further comprising said lever being hingedly pivotable at a fulcrum point.

11. The motorized armored cable cutter of claim 1, further comprising said housing having a switch configured to engage said motor.

12. The motorized armored cable cutter of claim 11, further comprising said switch is an electrical switch.

13. The motorized armored cable cutter of claim 11, further comprising said switch is a pneumatic switch.

14. The motorized armored cable cutter of claim 1, further comprising said secondary cable trough having a protrusion structure, said protrusion structure protruding from an inner wall surface of said second recess of said second cable trough.

15. The motorized armored cable cutter of claim 14, further comprising said protrusion structure having an end configured to tighten or loosen the tension of said protrusion structure on an armored cable.

16. The motorized armored cable cutter of claim 14, further comprising said protrusion structure is fixed in place.

17. The motorized armored cable cutter of claim 14, further comprising said protrusion structure a spring loaded ball, said spring loaded ball is configured to keep tension on an armored cable.

18. The motorized armored cable cutter of claim 1, further comprising said housing having a plurality of protrusions located on an inner wall surface of said housing, said plurality of protrusions are configured to support said power source, said motor, said gearbox, and said arbor.
